(19) United States
(12) Patent Application Publication
(10) Pub. No.: US 2008/0137246 A1
(43) Pub. Date: Jun. 12, 2008

(54) Relay system in substation and PCM current differential relay system

(75) Inventor: Shigetoo Oda, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Tokyo (JP)

(21) Appl. No.: 11/978,625

(22) Filed: Oct. 30, 2007

(30) Foreign Application Priority Data
Nov. 13, 2006 (JP) 2006-306625

(51) Int. Cl. H02H 3/027; H02H 7/045

(52) U.S. Cl. 361/64

(57) ABSTRACT

A PCM current differential relay is provided with a sampling synchronizing circuit unit which, on the basis of a deviation in sampling timing between digital current data of a local end and digital current data of a remote end inputted from the remote end, synchronizes the digital current data of the local end and the digital current data of the remote end. In accordance with the digital current data of the local end and the digital current data of the remote end synchronized by the sampling synchronizing circuit unit, relay operation of the PCM current differential relay is carried out by a relay operation unit of the PCM current differential relay.

### BACKGROUND OF THE INVENTION

1. Field of the Invention

The present invention relates to a relay system in an substation which have plural protective relays including a PCM current differential relay within the substation, and also to a PCM current differential relay system in which on the basis of a deviation in sampling timing between necessary digital current data of a local end inputted from a merging unit which merges digital data of the quantity of electricity sampled synchronously at various positions in the substation and digital current data inputted from a remote end, the digital current data of the local end and the digital current data of the remote end are synchronized.

2. Description of the Related Art

In a traditional digital transformation protection system, CT and PT output electric signals are sampled in sampling timing proper to the substation, then converted to digital signals, and inputted to plural protection relay devices via a digital network line. Each protective relay device executes protective relay operation using necessary data from the network line and applies its output for protection and control of each device in the substation. It is disclosed that, in order to realize PCM current differential relay to protect a transmission line connected to another substation, the sampling timing is corrected with reference to the sampling timing of a current transmitted from the remote substation on the transmission line via a PCM communication unit. It is also proposed that its correcting technique interpolates data corresponding to the deviation in sampling timing, of plural (usually two) local data (JP-A-10-66247, Third Embodiment, FIG. 3, FIG. 5).

As is clear from FIG. 3 and FIG. 5 of JP-A-10-66247, to synchronize sampling of a PCM current differential relay in the traditional digital transformation system, sampling of an A/D converter is carried out in a signal processing circuit in sampling timing proper to the substation, as preprocessing of a signal to be inputted to a protective relay (PCM current differential relay or the like), and the sampling is corrected by a digital operation unit with reference to the sampling timing of a current received from another substation device at a remote end of a transmission line. Consequently, current data coincident with the sampling timing of the substation at the remote end is applied to all the protective relays (for example, bus protection devices) that require the current data, except for the PCM current differential relay. Therefore, correction to the sampling timing of the substation at the remote end is similarly required in all the signal processing circuits. Alternatively, two types of data, that is, current data synchronized with the sampling timing of the substation at the remote end and data from the same CT but not synchronized with the other substation, must be provided to the network. Thus, there is a problem that processing becomes complicated. This is because, in protective relays based on differential principles such as bus protection devices, all input current signals must be converted to digital signals in the same sampling timing, and also because synchronization with the sampling timing of the remote end must be taken in the PCM current differential relay.

There is also a case where a transmission line from one substation is connected to plural other substations. In that case, the sampling timing must be corrected between the plural other substations. If the plural other substations have their respective proper sampling timing, the sampling timing is to be made coincident with the sampling timing proper to the plural other substations, in all the signal processing circuits in the one substation. That is, the sampling timing must be synchronized among all the substations, which may be difficult to realize.

### SUMMARY OF THE INVENTION

It is an object of the invention to cancel the influence of the synchronization of sampling timing with the other substation at the remote end in the PCM current differential relay for line protection, on the synchronization of sampling timing in other devices such as a bus protective relay.

According to an aspect of the invention, in a relay system in an substation having plural protective relays including a PCM current differential relay within the substation, synchronized digital data is inputted to the protective relay from a merging unit which merges digital data of quantity of electricity detected at each position in the substation and synchronously sampled. Moreover, the PCM current differential relay is provided with a sampling synchronizing circuit unit which, on the basis of a deviation in sampling timing between digital current data of a local end and digital current data of a remote end inputted from the remote end, synchronizes the digital current data of the local end and the digital current data of the remote end. On the basis of the digital current data of the local end and the digital current data of the remote end synchronized by the sampling synchronizing circuit unit, relay operation of the PCM current differential relay is carried out by a relay operation unit of the PCM current differential relay. Therefore, it is advantageous in that the influence of the synchronization of sampling timing with the other substation at the remote end in the PCM current differential relay for line protection, on the synchronization of sampling timing in other devices such as a bus protective relay, can be canceled.

According to another aspect of the invention, a PCM current differential relay is provided with a sampling synchronizing circuit unit which, on the basis of a deviation in sampling timing between necessary digital current data of a local end inputted from a merging unit that merges digital data of quantity of electricity detected at each position in an substation and synchronously sampled, and digital current data of a remote end inputted from the remote end, synchronizes the digital current data of the local end and the digital current data of the remote end. On the basis of the digital current data of the local end and the digital current data of the remote end synchronized by the sampling synchronizing circuit unit, relay operation of the PCM current differential relay is carried out by a relay operation unit of the PCM current differential relay. Therefore, it is advantageous in that the influence of the synchronization of sampling timing with the other substation at the remote end in the PCM current differential relay for line protection, on the synchronization of sampling timing in other devices such as a bus protective relay, can be canceled.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a first embodiment of the invention and showing an exemplary system configuration including a PCM current differential relay in a digital transformation system.

FIG. 2 is a block diagram showing the first embodiment of the invention and showing an exemplary internal configuration of the PCM current differential relay.

FIG. 3 is a view showing the first embodiment of the invention and showing an example of sampling timing (before correction) at both ends of a transmission line.

FIG. 4 is a vector diagram showing the first embodiment of the invention and showing an example of phase difference between both ends of a transmission line.

### DESCRIPTION OF THE PREFERRED EMBODIMENTS

### First Embodiment

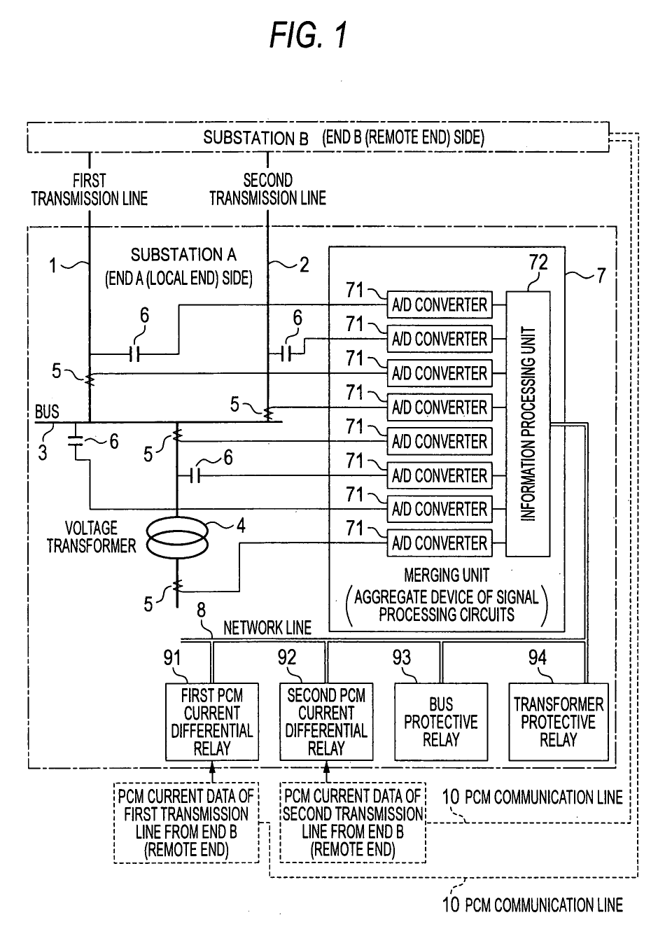

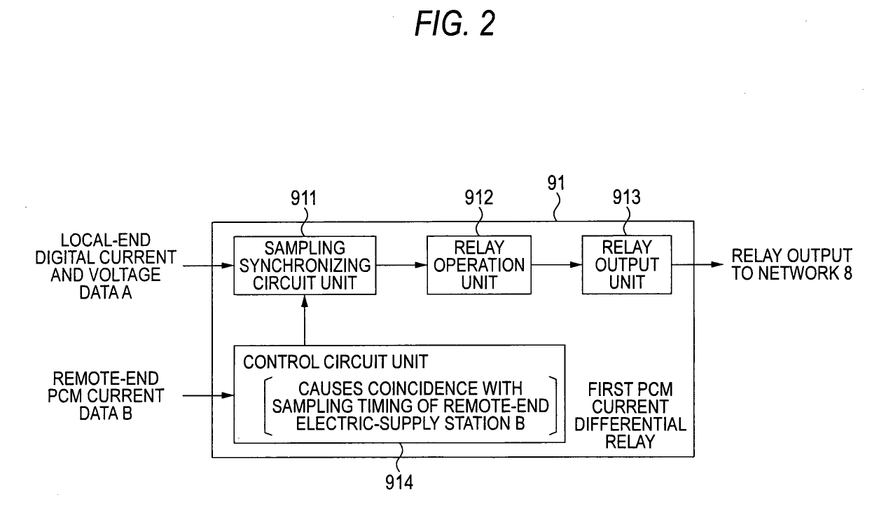

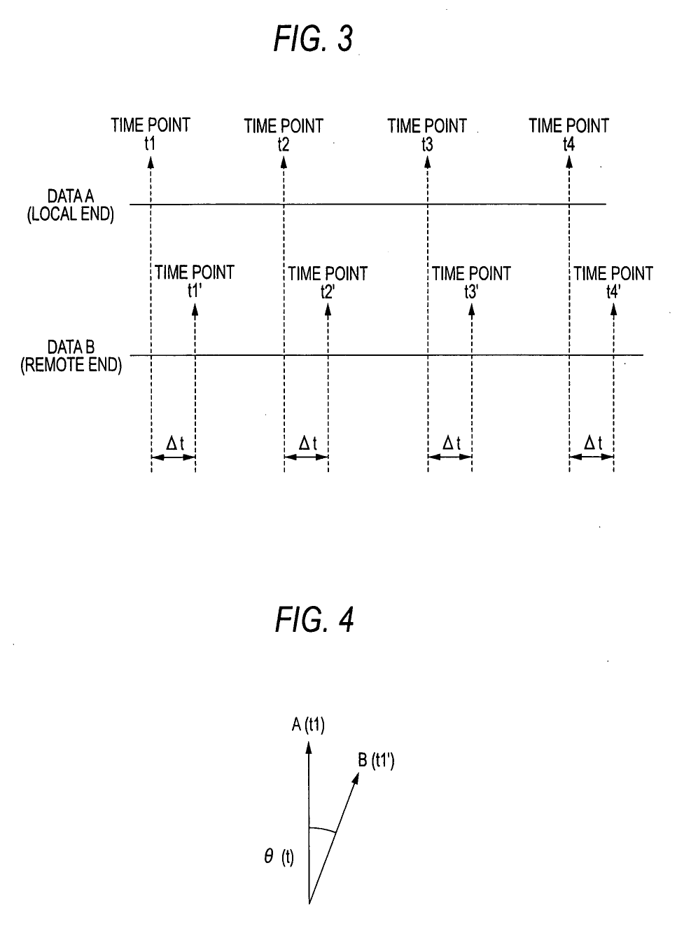

Hereinafter, a first embodiment of the invention will be described with reference to FIG. 1 to FIG. 4. FIG. 1 is a block diagram showing an exemplary system configuration including a PCM current differential relay in a digital transformation system. FIG. 2 is a block diagram an exemplary internal configuration of the PCM current differential relay. FIG. 3 is a view showing an example of sampling timing (before correction) at both ends of a transmission line. FIG. 4 is a vector diagram showing an example of phase difference between both ends of a transmission line. In the drawings, the same reference numerals represent the same parts.

FIG. 1 illustrates a digital transformation system in an substation A (end A (local end) side). In the substation in this example, a first transmission line 1 and a second transmission line 2 are connected to a bus 3, and power is supplied to a load (not shown) via a voltage transformer 4 from a feeder connected to the bus 3, as shown in FIG. 1.

As it is known, for example, the first transmission line 1, the second transmission line 2, the bus 3 and the feeder are provided with CT (current transformer for current detection) and PT (instrument transformer for voltage detection), which are illustrated. The outputs of these CT and PT are inputted via A/D converters (analog/digital converters) 71 of a single shared merging unit 7, which is an aggregate device of signal processing circuits, to an information processing unit 72 of the shared merging unit 7. Via a network 8 in the substation A, digital data such as necessary current and voltage for each predetermined operation are distributed from the information processing unit 72 of the shared merging unit 7 to a first PCM current differential relay 91, which protects the first transmission line 1, a second PCM current differential relay 92, which protects the second transmission line 2, a bus protective relay 93, which protects the bus 3, and a transformer protective relay 94, which protects the voltage transformer 4.

The first PCM current differential relay 91 has a sampling synchronizing circuit unit 911 which synchronizes digital current and voltage data A of the local end transmitted from the information processing unit 72 and PCM current data B from a remote end. The first PCM current differential relay 91 also has a relay operation unit 912 which receives the synchronized two current data from the sampling synchronizing circuit unit 911 and carries out relay operation as a PCM current differential relay. The first PCM current differential relay 91 also has an output unit 913 which outputs an output of the relay operation unit 912 (CB trip command) to the network 8.

In this embodiment, a control circuit unit 914 gives a command (control signal) to cause the sampling timing of the digital current and voltage data A of the local end to coincide with the sampling timing of the substation at the remote end (the sampling timing of the PCM current data B from the remote end), to the sampling synchronizing circuit unit 911. Alternatively, control to cause the sampling timing of the digital current B of the remote end to coincide with the sampling timing of the local end is conducted.

Also the second PCM current differential relay 92 has a configuration similar to the first PCM current differential relay 91 and functions similarly.

In this embodiment, the transmission lines 1 and 2 and the voltage transformer 4 connected to the bus 3 in the substation A (end A (local end) side) are described as representative components. The current and voltage at each site are inputted to the single merging unit (aggregate device of signal processing circuits) 7 by CT 5 and PT 6. In the merging unit 7, the A/D converters 71 convert the current and voltage of each site to digital data and the information processing unit 72 sequentially converts them to serial signals. The digital network 8 in the substation A connects these data to the required devices such as the protective relay devices 91, 92, 93 and 94. FIG. 1 illustrates, as a representative example, the configuration in which the data are inputted to the PCM current differential relays 91 and 92 as transmission line protective relays, the bus protective relay 93, and the transformer protective relay 94.

For example, in the PCM current differential relay 91, of these relays, the current and voltage data inputted from the merging unit 7 via the network 8 is inputted to the sampling synchronizing circuit unit 911. The sampling synchronizing circuit unit 911 is controlled to cause its sampling timing to coincide with the sampling timing of the current data from the PCM current differential relay at the remote end B of the transmission line 1. The relay operation circuit unit 912 is controlled to carry out relay operation based on the data of the two currents with the synchronized sampling timing. The output circuit unit 913, which gives a relay output in accordance with the result of the relay operation, outputs an output signal to the network 8. The corresponding CB (not shown) or the like is controlled by the signal.

That is, the sampling timing in the substation A is synchronized among the A/D converters 71 of the merging unit 7. The unified sampling timing is provided in the substation A. The sampling control at the PCM current differential relays 91 and 92, where the sampling timing must be synchronized with the PCM current differential relay in the substation at the remote end B, is carried out by the sampling synchronizing circuit 911 within the relays. Also, in the case of a relay which requires synchronized sampling of all the currents connected to the bus 3, as in the bus protective relay 93, sampling control (sampling synchronization control) is carried out in the merging unit 7 and therefore sampling control (sampling synchronization control) within the relay is not necessary.

Next, a control system in the sampling synchronizing circuit will be described with reference to FIG. 3.

Time data of digitized timing (sampling timing) is added to the current and voltage digital data on the network.

The data of the substation A at the local end (referred to as “data A”) flows at t1, t2, t3, . . . in accordance with the sampling timing as shown in FIG. 3. Also the digital data from the substation B at the remote end is transmitted at t1′, t2′, t3′, . . . through a PCM communication line 10 of the PCM current differential relay at the remote end B. Here, the sampling cycle is assumed to be the same at both ends in order to simply the description.

For example, in the case where the difference in sampling time point between the remote end B and the local end A is expressed by Δt on the basis of voltage information, there is a time difference of Δt between data sampled at the remote end B and data sampled at the local end A. Thus, the local-end data is corrected by Δt (FIG. 3 shows a state where the local-end data A is delayed from the data B of the remote end B by Δt), thereby providing the local-end data synchronized in time with the remote end. (There is also a technique of correcting the remote-end data by −Δt, but the case of correcting the local-end data is described here.)

The system for this will be described hereinafter.

### (1) The phase angle θ equivalent to Δt is calculated.

0=360°×(Δt/time of one cycle (20 ms for 50 Hz and 16.667 ms for 60 Hz))

### (2) The phase is corrected by θ.

A(t′)=A(t)×cos θ+A(t−90°)×sin θ

Here, A(t′) is data after correction and A(t) is data before correction. In this example, data preceding and following the data before correction by 90° are used. However, to improve accuracy, consecutive two data (A(t) and A(t−T), where T is sampling time) are employed. In the case where the electrical angle is T=30°,

A(t′)=a×A(t)+b×A(t−T)

holds, and according to the sine theorem,

a/sin(30°−θ)=b/sin θ=1/sin 150°

holds. From this, a and b are calculated by

a=(sin(30°−θ)/sin 150°, b=sin θ/sin 150°

Thus, the correction value A(t′) can be calculated. The correction angle θ is smaller than the electrical angle 30° equivalent to the sampling cycle T.

### (3) PCM current differential relay operation is carried out on the basis of the data after correction and the received data from the remote end.

In this manner, in the PCM current differential relay according to this embodiment, the time difference from the remote-end data is found on the basis of the time data added to the data. The phase angle to be corrected is calculated in accordance with the time difference. Phase correction is carried out using two sampling data. Therefore, there is an advantage that the sampling timing can be easily and accurately controlled in the form of phase correction.

In this embodiment, the substation B is configured similarly to the substation A. Also, the time of the clock that serves as the basis of the time of time data added to the data at the substation B and the substation A is coincident between the substation B and the substation A.

### Second Embodiment

In the first embodiment, the time difference from the sampling timing of the PCM current differential relay at the remote end is calculated on the basis of the time added to the data, and the time difference is converted to a phase difference to correct the phase, thereby realizing time synchronization. Here, however, the absolute phase of two consecutive digital data is calculated to correct data.

This will be described hereinafter.

### (1) The phase angle θ equivalent to time difference Δt is calculated, as in (1) of the first embodiment.

θ=360°×(Δt/time of one cycle (20 ms for 50 Hz and 16.667 ms for 60 Hz))

### (2) Two consecutive local-end data are expressed as follows.

A(t)=A×sin(ωt+Φ)

A(t−T)=A×sin(ωt+Φ−α)

where α is the electrical angle (for example, 30°) equivalent to the time difference T of the two consecutive data.

### (3) The amplitude A and the phase angle Φ are calculated in accordance with the above two equations.

### (4) Phase correction by θ is made on A(t) to provide data A(t′) after correction.

A(t′)=A×sin(ωt+−Φ−θ)

### Since this data A(t′) after correction has the same sampling timing as the end B, PCM current differential relay operation is carried out using this data and B(t′) of the remote end.

As in the first embodiment, there is an advantage that correction can be made accurately by simple operation.

In the case where three consecutive local-end data are used, the amplitude A, the phase Φ and the angular frequency ω can be acquired from

A(t)=A×sin(ωt+Φ)

A(t−T)=A×sin(ωt+Φ−α)

A(t−2T)=A×sin(ωt+Φ−2α)

### Therefore, if ω is not fixed at the rated frequency, more accurate operation can be carried out using the three data.

### Third Embodiment

In the first and second embodiments, the time difference from the sampling timing of the PCM current differential relay of the remote end is calculated in accordance with the time added to the data. However, in the third embodiment, it is calculated on the basis of the phase difference between the current data at both ends in normal operation. This is advantageous in that the time data need not be sent to the remote end and that data can be simplified as a PCM signal. When the system is experiencing failure, the current phase quickly changes. Therefore, the correction is interrupted and the correction value before the failure is maintained.

An example of calculating the difference in accordance with the phase difference between the current data at both ends in normal operation will be described hereinafter.

### (1) Two consecutive local-end data are expressed as follows.

A(t)=A×sin(ωt+Φ)

A(t−T)=A×sin(ωt+Φ−α)

where α is the electrical angle (for example, 30°) equivalent to the time difference T of the two consecutive data.

### (2) The amplitude A and the phase angle Φ are calculated in accordance with the above two equations.

### (3) Similarly, consecutive remote-end data are expressed as follows.

B(t′)=B×sin(ωt′+Φ′)

B(t′−T)=B×sin(ωt′+Φ′−α)

### The time difference of the two consecutive data is similarly α at both ends.

### (4) The amplitude B and the phase angle Φ′ are calculated in accordance with the two equations in the above section (3).

### (5) The difference ΔΦ between the phase angles Φ and Φ′ is calculated.

ΔΦ=Φ−Φ′

### (6) Phase shift of the local-end data by ΔΦ is carried out to align with the phase of the remote end.

Local-end data A(t′) after correction=A×sin(ωt′+Φ−ΔΦ)

### The phases at both ends are thus aligned to realize time synchronization.

As the phase difference in the normal state is caused to be zero without using the time data at both ends, the current difference between the currents at both ends of the transmission line can be reduced. Although there is a problem that interruption of control at the time of failure needs to be considered, the correction time data of the sampling timing need not be included and sent in the PCM signal and therefore there is an advantage that the PCM data can be simplified.

The features of the above first to third embodiments will be described hereinafter.

Feature 1: It relates to a technique of controlling sampling synchronization for currents of both ends in a PCM current differential relay that protects a power transmission line, in a digital transformation protection system in which AC output signals of CT, PT and so on are connected to plural protection devices of devices at each substation via a digital network line and an output of each protection device is controlled via the network line.

Feature 2: To synchronize sampling of the PCM current differential relay with another substation, A/D-converted data is inputted to the PCM relay in sampling timing proper to the substation, instead of a signal processing circuit, and then the phase difference due to the difference in sampling timing from the other substation is corrected. Thus, the difference in sampling timing is substantially corrected.

Feature 3: As the first correcting technique, since digital data on the network has time data of each data added thereto, the time data is sent and received together with the current data synchronously with the PCM signal, and the time difference between the data of the remote end and the local end is calculated in accordance with the time data of the local end and the remote end. This time difference is equivalent to the difference in sampling timing between both ends. The electrical angle phase difference equivalent to the time difference is calculated and the phase difference is corrected at each end.

Feature 4: As the second correcting technique, the amplitude and phase of input data are calculated using two or three consecutive sampling data, and in accordance with the result of it, the phase difference between the local end and the remote end is calculated. The phase difference is corrected at each terminal similarly to the first correcting technique. In the case where two consecutive data are used, the amplitude and phase are provided. In the case where three consecutive data are used, the frequency can be provided as well as the amplitude and phase. Therefore, three consecutive data are used if frequency change is anticipated.

Feature 5: The correction of the sampling timing with respect to the other substation at the remote end can be carried out without affecting the sampling timing of another bus protective relay or the like which uses A/D-converted digital data similarly at the sampling timing proper to the substation or without affecting the correction of the sampling timing of another PCM current differential relay which protects a transmission line to another substation different from the above substation.

Feature 6: In an substation where various data of CT, PT and so on of a power system are digitized and networked with each protective and control device within the substation, a PCM current differential relay is characterized by having a sampling synchronizing circuit is provided which synchronizes its sampling timing with the sampling timing of another substation. In the synchronization processing, the phase difference is calculated on the basis of the difference in current time data between the local end and the other end. As the sampling data is phase-shifted to correct the phase difference and synchronized data is thus provided.

Feature 7: A sampling synchronization processing system is characterized in that, in the PCM current differential relay according to Feature 7, a sampling synchronizing circuit is provided which synchronizes its sampling timing with the sampling timing of another substation. In the synchronization processing, the phase electrical angle is calculated on the basis of the difference in current time data between the local end and the other end. The amplitude and phase are calculated using two consecutive data of the sampling data, and the electrical angle is corrected to the phase to provide instantaneous value data. Thus, data with synchronized sampling timing can be provided.

Feature 8: A sampling synchronization processing system is characterized in that, in the sampling synchronization processing in the PCM current differential relay according to Feature 7, the phase difference between currents at both ends is measured from the current data of the local end and the other end. By the method of correcting the phase difference, synchronization with the sampling timing of the remote end is realized.

Feature 9: In a relay system in an substation having plural protective relays including a PCM current differential relay within the substation, synchronized digital data is inputted to the protective relay from a merging unit which merges digital data of quantity of electricity detected at each position in the substation and synchronously sampled. The PCM current differential relay is provided with a sampling synchronizing circuit unit which synchronizes digital current data of the local end and digital current data of the remote end on the basis of a deviation in sampling timing between the digital current data of the local end and the digital current data of the remote end inputted from the remote end. Relay operation of the PCM current differential relay is carried out by a relay operation unit of the PCM current differential relay in accordance with the digital current data of the local end and the digital current data of the remote end synchronized by the sampling synchronizing circuit unit.

Feature 10: In a PCM current differential relay system, a PCM current differential relay is provided with a sampling synchronizing circuit unit which, on the basis of a deviation in sampling timing between necessary digital current data of the local end inputted from a merging unit that merges digital data of quantity of electricity detected at each position in an substation and synchronously sampled and digital current data of the remote end inputted from the remote end, synchronizes the digital current data of the local end and the digital current data of the remote end. Relay operation of the PCM current differential relay is carried out by a relay operation unit of the PCM current differential relay in accordance with the digital current data of the local end and the digital current data of the remote end synchronized by the sampling synchronizing circuit unit.

Feature 11: In the PCM current differential relay system according to Feature 11, the digital current data of the remote end is outputted from a merging unit which merges digital data of quantity of electricity detected at each position in an substation at the remote end and synchronously sampled.

Feature 12: In the PCM current differential relay system according to Feature 11 or Feature 12, both the digital current data of the local end and the digital current data of the remote end have time data of each sampling time point. A phase shift is carried out by the phase difference equivalent to the difference between the respective sampling times, and the current data of the local end and the current data of the remote end are thus synchronized.

Feature 13: In the PCM current differential relay system according to Feature 11 or Feature 12, both the digital current data of the local end and the digital current data of the remote end have time data of each sampling time point. On the basis of the phase angle θ equivalent to the difference between the respective sampling times, the electrical angle α equivalent to the time difference of the consecutive local-end data and the phase angle Φ of the local-end data, correction data A(t′) is calculated within the PCM current differential relay to synchronize the current data of the local end and the current data of the remote end.

Feature 14: In the PCM current differential relay system according to Feature 11 or Feature 12, a phase shift is carried out by the difference ΔΦ between the phase angle Φ of the digital current data of the local end and the phase angle Φ′ of the digital current data of the remote end. The current data of the local end and the current data of the remote end are thus synchronized.

Various modifications and alterations of this invention will be apparent to those skilled in the art without departing from the scope and spirit of this invention, and it should be understood that this is not limited to the illustrative embodiments set forth herein.

What is claimed is:

1. A relay system in an substation having plural protective relays including a PCM current differential relay within the substation,
wherein synchronized digital data is inputted to the protective relay from a merging unit which merges digital data of quantity of electricity detected at each position in the substation and synchronously sampled, and
the PCM current differential relay is provided with a sampling synchronizing circuit unit which, on the basis of a deviation in sampling timing between digital current data of a local end and digital current data of a remote end inputted from the remote end, synchronizes the digital current data of the local end and the digital current data of the remote end, and on the basis of the digital current data of the local end and the digital current data of the remote end synchronized by the sampling synchronizing circuit unit, relay operation of the PCM current differential relay is carried out by a relay operation unit of the PCM current differential relay.

2. A PCM current differential relay system wherein a PCM current differential relay is provided with a sampling synchronizing circuit unit which, on the basis of a deviation in sampling timing between necessary digital current data of a local end inputted from a merging unit that merges digital data of quantity of electricity detected at each position in an substation and synchronously sampled and digital current data of a remote end inputted from the remote end, synchronizes the digital current data of the local end and the digital current data of the remote end, and on the basis of the digital current data of the local end and the digital current data of the remote end synchronized by the sampling synchronizing circuit unit, relay operation of the PCM current differential relay is carried out by a relay operation unit of the PCM current differential relay.

3. The PCM current differential relay system according to claim 2, wherein the digital current data of the remote end is outputted from a merging unit which merges digital data of quantity of electricity detected at each position in an substation at the remote end and synchronously sampled.

4. The PCM current differential relay system according to claim 2, wherein both the digital current data of the local end and the digital current data of the remote end have time data of each sampling time point, and a phase shift is carried out by a phase difference equivalent to the difference between the respective sampling times, thereby to synchronize the current data of the local end and the current data of the remote end.

5. The PCM current differential relay system according to claim 3, wherein both the digital current data of the local end and the digital current data of the remote end have time data of each sampling time point, and a phase shift is carried out by a phase difference equivalent to the difference between the respective sampling times, thereby to synchronize the current data of the local end and the current data of the remote end.

6. The PCM current differential relay system according to claim 2, wherein both the digital current data of the local end and the digital current data of the remote end have time data of each sampling time point, and on the basis of a phase angle θ equivalent to the difference between the respective sampling times, an electrical angle α equivalent to the time difference of consecutive local-end data and a phase angle Φ of the local-end data, correction data A(t′) is calculated within the PCM current differential relay to synchronize the current data of the local end and the current data of the remote end.

7. The PCM current differential relay system according to claim 3, wherein both the digital current data of the local end and the digital current data of the remote end have time data of each sampling time point, and on the basis of a phase angle θ equivalent to the difference between the respective sampling times, an electrical angle α equivalent to the time difference of consecutive local-end data and a phase angle Φ of the local-end data, correction data A(t′) is calculated within the PCM current differential relay to synchronize the current data of the local end and the current data of the remote end.

8. The PCM current differential relay system according to claim 2, wherein a phase shift is carried out by a difference ΔΦ between a phase angle Φ of the digital current data of the local end and a phase angle Φ′ of the digital current data of the remote end, thereby to synchronize the current data of the local end and the current data of the remote end.

9. The PCM current differential relay system according to claim 3, wherein a phase shift is carried out by a difference ΔΦ between a phase angle Φ of the digital current data of the local end and a phase angle Φ′ of the digital current data of the remote end, thereby to synchronize the current data of the local end and the current data of the remote end.
